(19) United States
(12) Patent Application Publication
(10) Pub. No.: US 2012/0132468 A1
(43) Pub. Date: May 31, 2012

(54) CUTTER WITH DIAMOND SENSORS FOR ACQUIRING INFORMATION RELATING TO AN EARTH-BORING DRILLING TOOL

(75) Inventors: Dan E. Scott, Montgomery, TX (US); Anthony A. DiGiovanni, Houston, TX (US)

(73) Assignee: BAKER HUGHES INCORPORATED, HOUSTON, TX (US)

(21) Appl. No.: 13/296,905

(22) Filed: Nov. 15, 2011

Related U.S. Application Data
(60) Provisional application No. 61/418,217, filed on Nov. 30, 2010.

(51) Int. Cl. E21B 47/00; B01J 3/06; B05D 3/02; E21B 10/36; B24D 3/00

(52) U.S. Cl. 175/50; 175/428; 51/295

(57) ABSTRACT

Methods and associated tools and components related to generating and obtaining performance data during drilling operations of a subterranean formation is disclosed. Performance data may include thermal and mechanical information related to earth-boring drilling tool during a drilling operation are disclosed. For example, a cutter of an earth-boring drilling tool may include a substrate with a cutting surface thereon. The cutter may further include at least one diamond sensor coupled with the cutting surface, and a conductive pathway operably coupled with the at least one diamond sensor. The at least one diamond sensor may be configured to generate a piezoelectric signal in response to an applied stimulus.

### CROSS-REFERENCE TO RELATED APPLICATIONS

This application claims priority from U.S. Provisional Application Ser. No.: 61/418,217, filed Nov. 30, 2010 the disclosure of which is incorporated herein by reference in its entirety.

### BACKGROUND OF THE DISCLOSURE

1. Field of the Disclosure

The present disclosure generally relates to devices and methods for acquiring information relating to earth-boring drill bits, cutters attached thereto, and other tools that may be used while drilling subterranean formations.

2. Background

Information relating to a drill bit and certain components of the drill bit may be useful for characterizing and evaluating the durability, performance, and the potential failure of the drill bit. Often, such information is obtained by inspecting a drill bit after use. The present disclosure addresses the need to obtain information relating to performance or behavior of a drill bit and related components while the drill bit is being used.

### BRIEF SUMMARY OF THE DISCLOSURE

In aspects, the present disclosure provides a cutter for an earth-boring drilling tool. The cutter may include a cutting element and at least one diamond crystal at least partially embedded in the cutting element. The diamond crystal(s) may generate a piezoelectric signal when the cutting element is drilling a borehole.

In aspects, the present disclosure provides a method for forming a cutter for an earth-boring drilling tool. The method may include at least partially embedding at least one diamond crystal in a cutting element. The diamond crystal(s) may generate a piezoelectric signal when the cutting element is drilling a borehole.

In aspects, the present disclosure provides a method for measuring a property of a cutter of an earth-boring drilling tool. The method may include determining the property of the cutting element using a piezeoelectric response of a diamond crystal embedded in the cutting element.

These features, advantages, and alternative aspects of the present disclosure will be apparent to those skilled in the art from a consideration of the following detailed description taken in combination with the accompanying drawings.

### BRIEF DESCRIPTION OF THE DRAWINGS

While the specification concludes with claims particularly pointing out and distinctly claiming that which is regarded as the present disclosure, the advantages of this disclosure may be more readily ascertained from the following description of the disclosure when read in conjunction with the accompanying drawings in which:

FIG. 1 illustrates a cross-sectional view of an exemplary earth-boring drill bit;

FIG. 2A illustrates an isometric view of a cutter according to an embodiment of the present disclosure;

FIG. 2B illustrates a sectional view of a cutter prior to finishing according to an embodiment of the present disclosure;

FIG. 2C illustrates a sectional view of a cutter after finishing according to an embodiment of the present disclosure; and

FIGS. 3A and 3B illustrate a cutter having a data communication system according to another embodiment of the present disclosure.

### DETAILED DESCRIPTION OF THE DISCLOSURE

The illustrations presented herein are not meant to be actual views of any particular material, apparatus, system, or method, but are merely idealized representations which are employed to describe the present disclosure. Additionally, elements common between figures may have a similar numerical designation.

As used herein, a “drill bit” means and includes any type of bit or tool used for drilling during the formation or enlargement of a wellbore in subterranean formations and includes, for example, fixed cutter bits, rotary drill bits, percussion bits, core bits, eccentric bits, bi-center bits, reamers, mills, drag bits, roller cone bits, hybrid bits and other drilling bits and tools known in the art.

As used herein, the term “polycrystalline material” means and includes any material comprising a plurality of grains or crystals of the material that are bonded directly together by inter-granular bonds. The crystal structures of the individual grains of the material may be randomly oriented in space within the polycrystalline material.

As used herein, the term “polycrystalline compact” means and includes any structure comprising a polycrystalline material formed by a process that involves application of pressure (e.g., compaction) to the precursor material or materials used to form the polycrystalline material.

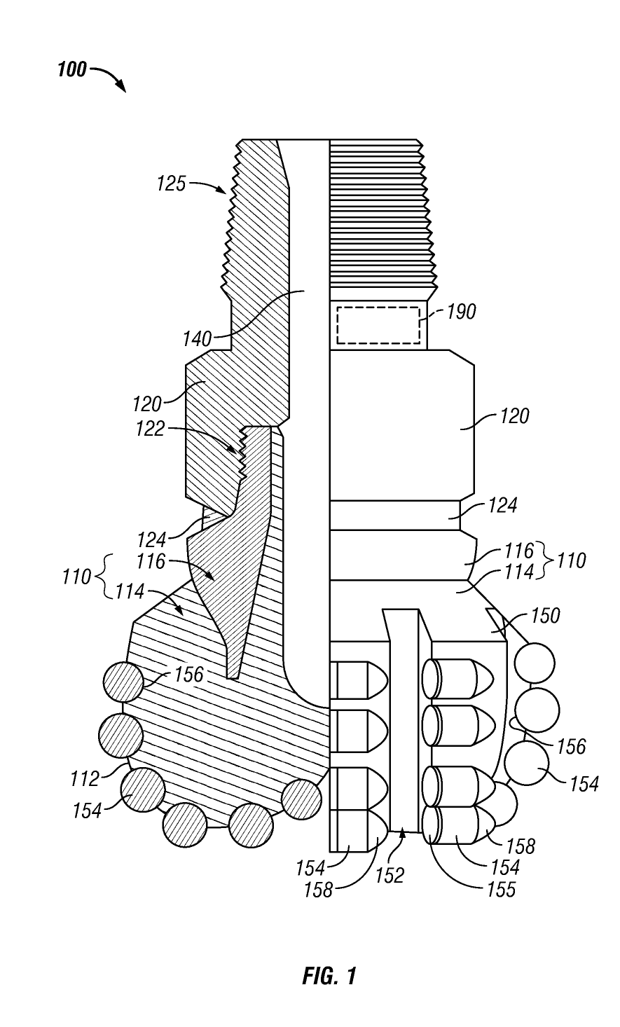

FIG. 1 illustrates a cross-sectional view of an exemplary earth-boring drill bit 100. Earth-boring drill bit 100 includes a bit body 110. The bit body 110 of an earth-boring drill bit 100 may be formed from steel. Alternatively, the bit body 110 may be formed from a particle-matrix composite material.

The earth-boring drill bit 100 may include a plurality of cutters 154 attached to the face 112 of the bit body 110. Generally, the cutters 154 of a fixed-cutter type drill bit have either a disk shape or a substantially cylindrical shape. A cutter 154 includes a cutting surface 155 located on a substantially circular end surface of the cutter 154. The cutter 154 may be formed by disposing a hard, super-abrasive material, such as mutually bound particles of polycrystalline diamond formed into a diamond table under high pressure, high temperature conditions, on a supporting substrate. Conventionally, the diamond table may be formed onto the substrate during the high pressure, high temperature process, or may be bonded to the substrate thereafter. Such cutters 154 are often referred to as a polycrystalline compact or a “polycrystalline diamond compact” (PDC) cutter 154. The cutters 154 may be provided along the blades 150 within pockets 156 formed in the face 112 of the bit body 110, and may be supported from behind by buttresses 158, which may be integrally formed with the crown 114 of the bit body 110. Cutters 154 may be fabricated separately from the bit body 110 and secured within the pockets 156 formed in the outer surface of the bit body 110. If the cutters 154 are formed separately from the bit body 110, a bonding material (e.g., adhesive, braze alloy, etc.) may be used to secure the cutters 154 to the bit body 110.

The bit body 110 may further include wings or blades 150 that are separated by junk slots 152. Internal fluid passageways (not shown) extend between the face 112 of the bit body 110 and a longitudinal bore 140, which extends through the steel shank 120 and partially through the bit body 110. Nozzle inserts (not shown) also may be provided at the face 112 of the bit body 110 within the internal fluid passageways.

The earth-boring drill bit 100 may be secured to the end of a drill string (not shown), which may include tubular pipe and equipment segments coupled end to end between the earth-boring drill bit 100 and other drilling equipment at the surface of the formation to be drilled. As one example, the earth-boring drill bit 100 may be secured to the drill string with the bit body 110 being secured to a steel shank 120 having a threaded connection portion 125 and engaging with a threaded connection portion of the drill string. An example of such a threaded connection portion is an American Petroleum Institute (API) threaded connection portion. The bit body 110 may further include a crown 114 and a steel blank 116. The steel blank 116 is partially embedded in the crown 114. The crown 114 may include a particle-matrix composite material such as, for example, particles of tungsten carbide embedded in a copper alloy matrix material. The bit body 110 may be secured to the shank 120 by way of a threaded connection 122 and a weld 124 extending around the drill bit 100 on an exterior surface thereof along an interface between the bit body 110 and the steel shank 120. Other methods for securing the bit body 110 to the steel shank 120 exist.

In embodiments, the drill bit 100 may include a data collection module 190. The module 190 may include components such as, for example, an analog-to-digital converter, analysis hardware/software, displays, and other components for collecting and/or interpreting data generated by the sensors in the drill bit 100. For example, some earth-boring drill bits including such a processing module may be termed a “Data Bit” module-equipped bit, which may include electronics for obtaining and processing data related to the bit and the bit frame, such as is described in U.S. Pat. No. 7,604,072 which issued Oct. 20, 2008 and entitled Method and Apparatus for Collecting Drill Bit Performance Data, the entire disclosure of which is incorporated herein by this reference.

During drilling operations, the drill bit 100 is positioned at the bottom of a well bore hole such that the cutters 154 are adjacent the earth formation to be drilled. Equipment such as a rotary table or top drive may be used for rotating the drill string and the drill bit 100 within the bore hole. Alternatively, the shank 120 of the drill bit 100 may be coupled directly to the drive shaft of a down-hole motor, which then may be used to rotate the drill bit 100. As the drill bit 100 is rotated, drilling fluid is pumped to the face 112 of the bit body 110 through the longitudinal bore 140 and the internal fluid passageways (not shown). Rotation of the drill bit 100 causes the cutters 154 to scrape across and shear away the surface of the underlying formation. The formation cuttings mix with, and are suspended within, the drilling fluid and pass through the junk slots 152 and the annular space between the well bore hole and the drill string to the surface of the earth formation.

When the cutters scrape across and shear away the surface of the underlying formation, a significant amount of heat and mechanical stress may be generated. Components of the drill bit 100 (e.g., cutters 154) may be configured to acquire information relating to the behavior, performance, and/or environmental conditions of such components during drilling operations. For example, embodiments of the present disclosure may include diamond sensors embedded in one or more cutters 154 of the earth-boring drill bit 100. Based on a piezoelectric response of the diamond sensors, information relating to the performance of the cutter 154, such as thermal and mechanical (e.g., stresses and pressures) data may be obtained. Although cutters 154 are illustrated and described herein as exemplary, embodiments of the present disclosure may include other components within the drill bit 100 being configured for obtaining information related to the drill bit 100 diamond sensors that exhibit a piezoelectric response.

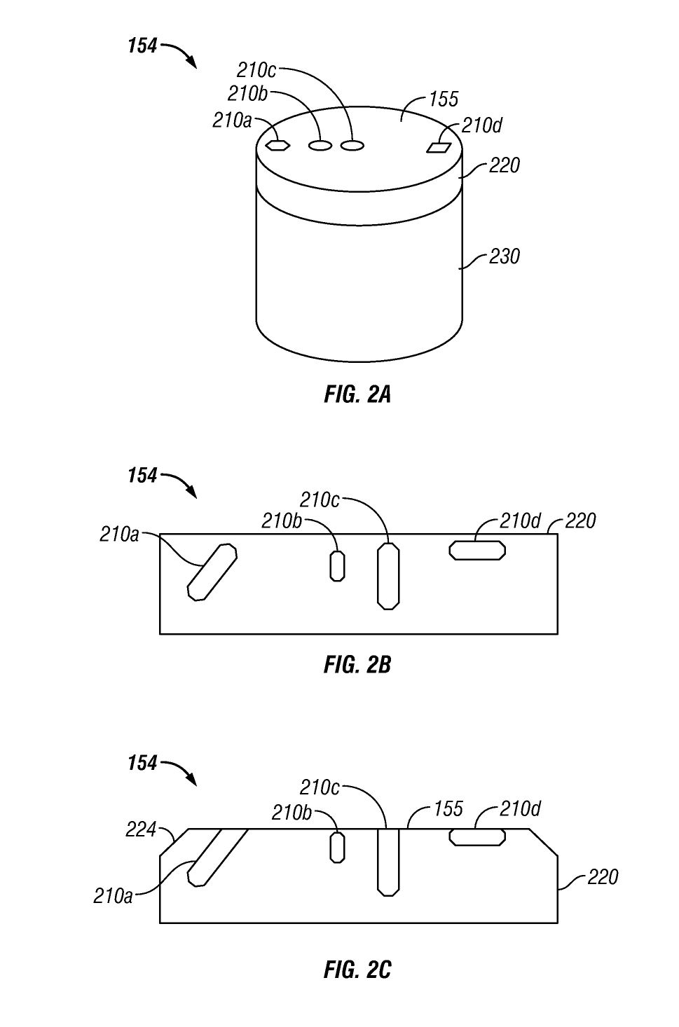

FIGS. 2A-C illustrate a cutter 154 according to an embodiment of the present disclosure. Cutter 154 may be included in an earth-boring drill bit, such as, for example an earth-boring drill bit similar to the one described in reference to FIG. 1. FIG. 2A isometrically illustrates a cutter 154 that includes one or more sensors 210a-d embedded in a cutting element 220 formed on a substrate 230. By embedded, it is meant that the sensors may be positioned in or on the cutting element 220. In some embodiments, the diamond sensors 210a-d are embedded before the cutter 154 is processed (e.g., HPHT synthesis) and finished. In other embodiments, the diamond sensors 210a-d are embedded during or after processing and finishing. The sensors 210a-d may be formed from a diamond material, and may be referred to as a diamond sensor 210a-d. The cutting element 220 may be formed at least partially of polycrystalline diamond material, e.g., polycrystalline diamond compact (PDC). As will be described later, each diamond sensor 210a-d may be in data communication with a data acquisition module 190 (FIG. 1).

The diamond sensors 210a-d may be configured for providing environmental information such as temperature and/or pressure during the rock cutting process. Diamond sensors 210a-d may include a single crystal diamond or a polycrystalline diamond. The diamond material may be natural or synthetic single crystal diamond materials. The diamond sensors 210a-d may be configured to generate a piezoelectric signal in response to an applied stimulus (e.g., mechanical stresses, pressure, temperature, etc.). Generally, the piezoelectric signal may be an electrical voltage having a known relationship to an applied stimulus, such as pressure or temperature. The diamond sensors 210a-d may be spatially distributed on the cutting element 220 and may have non-uniform sizes, depths, aspect ratios and/or crystallographic orientations.

FIG. 2B sectionally shows a cutter 154 before finishing. The diamond sensors 210a-d may be embedded in the cutting element 220 prior to a high pressure/high temperature (HPHT) synthesis. HPHT synthesis is a known process wherein a core reaction cell may be subjected to extreme temperatures and pressures to replicate the process during which natural diamonds are formed. The reaction cell may include a carbon source and possibly some seed crystals. The temperatures and pressures are selected to convert the carbon source into a diamond structure. During HPHT synthesis, the crystal diamonds, which may be single crystal diamonds, may retain substantially all of their original volume, may be partially consumed, reduce in volume, partially grow in one or more crystallographic directions, or increase in volume. Also, the forces applied during HPHT synthesis may break a single crystal diamond into one or more pieces. These pieces may undergo a change in volume as described previously. Furthermore, one or more of the aggregate of normal micron diamond grains from a diamond feedstock may be promoted to grow via abnormal grain growth into an elongated or enlarged structure relative to the rest of a PDC matrix.

FIG. 2C shows a cutter 154 finished to specification after HPHT synthesis. Finishing may include processing such as grind, lapping, etc. During the finishing process, the cutting surface 155 may be formed as well as other features, such as chamfers 224. The finishing process may also expose surfaces 212a-d of the diamond sensors 210a-d on the surface 155 of the cutting element 220. As shown in FIGS. 2A-C, the diamond sensors 210a-d may be positioned in the upper portion of the cutting element 220. In other embodiments, the diamond sensors 210a-d may be located at any location of the cutter 154, including areas in the lower portion of the cutting element 220 or the substrate 230. For some cutters 154, the substrate 230 (FIG. 2A) and the cutting element 220 may be integrally formed from the same material.

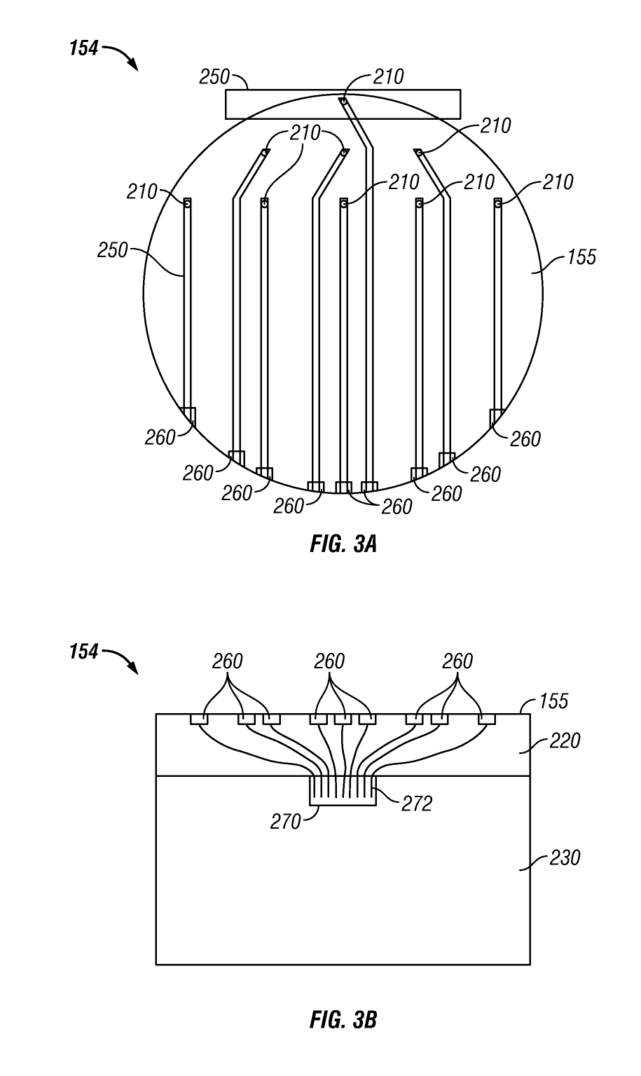

FIGS. 3A and 3B illustrate a signal transfer system for a cutter 154 according to an embodiment of the present disclosure. As shown in FIG. 3A, the cutter 154 may include one or more diamond sensors 210, conductive paths 250, and terminations 260. Each diamond sensor 210 may be operably coupled to a corresponding termination 260 through a conductive path 250. That is, the terminations 260 may be configured to receive a voltage signal generated by the diamond sensors 210 via the conductive pathway 250. The conductive pathways 250 may be formed from an electrically conductive material sufficient to place the diamond sensors 210 in electrical communication with the terminations 260. The terminations 260 may also be formed from a conductive material (e.g., metal, metal alloy, etc.).

In some embodiments, the conductive pathways 250, and terminations 260 may be deposited on the cutting surface 155 of the cutter 154. Alternatively, the conductive pathways 250, and terminations 260 may be at least partially embedded within the cutting element 220. For example, FIG. 3B shows the metal terminations 260 at least partially embedded within the cutting element 220 of the cutter 154. Embedding may be accomplished by forming depressions (e.g., grooves, trenches) in the cutting surface 155 and depositing the appropriate materials for the conductive pathways 250, and terminations 260 within the depressions. Depositing the appropriate materials within the depressions may result in the conductive pathways 250 and terminations 260 forming a substantially smooth (i.e., flush) surface with the cutting surface 155. Forming the depressions may be accomplished during formation of the cutter 154 or through machining, such as electro-discharge machining, or EDM, laser etching or machining, or other similar techniques as known by those of ordinary skill in the art, after formation of the cutter 154.

FIG. 3B also illustrates that the terminations 260 may be coupled to a port 270, which may include a plurality of channels for communication of data signals to a data collection module (not shown). The terminations 260 may operably couple to the port 270 with conductive elements 272 (e.g., electrical wiring, patterned metallization). Conductive elements 272 may extend along the surface 155, or be at least partially buried (i.e., embedded) within the cutter 154. It is noted that conductive elements 272 are shown as single lines for simplicity, but such each of conductive elements 272 may include two-way conductive paths.

In operation, the port 270 may receive electrical signals representative of an applied stimulus (e.g., pressure or temperature) from the diamond sensors 210 through conductive pathways 240, terminations 260, and conductive elements 272, and convey the signals to a data collection module 190 (FIG. 1). Such data transmission from the port 270 to the data acquisition module may include wired or wireless communication. Port 270, conductive elements 272, or both, may be interfaced with a processing module within the drill bit itself.

Another embodiment of the present disclosure may include the diamond sensor being configured as a micro-electro-mechanical system (MEMS) device, which MEMS device may include one or more elements integrated on a common substrate. Such elements may include sensors, actuators, electronic and mechanical elements. The MEMS device may include a crystal diamond that exhibits a piezoelectric response. The MEMS device may be configured to detect temperature or mechanical properties (e.g., pressure) of the cutting element. The MEMS device may be operably coupled with conductive pathways. Such an embodiment including one or more MEMS device may also include insulating layers and hardened layers.

Although the foregoing description contains many specifics, these are not to be construed as limiting the scope of the present disclosure, but merely as providing certain exemplary embodiments. Similarly, other embodiments of the disclosure may be devised which do not depart from the scope of the present disclosure.

What is claimed is:

1. A cutter for an earth-boring drilling tool, the cutter comprising:
a cutting element; and
at least one diamond crystal at least partially embedded in the cutting element, the at least one diamond crystal configured to generate a piezoelectric signal when the cutting element is drilling a borehole.

2. The cutter of claim 1, further comprising a data acquisition module configured to receive the piezoelectric signal from the at least one diamond crystal.

3. The cutting element of claim 1, wherein the at least diamond crystal further comprises a single diamond crystal.

4. The cutting element of claim 1, wherein the at least one diamond crystal further comprises a polycrystalline crystal.

5. The cutting element of claim 1, wherein the piezoelectric signal is indicative of an applied pressure.

6. The cutting element of claim 1, wherein the cutting element further comprises a conductive pathway in communication with the at least one diamond crystal.

7. The cutting element of claim 1, wherein the at least one diamond crystal further comprises a plurality of diamond crystals.

8. The cutting element of claim 1, wherein the cutting element further comprises at least a polycrystalline diamond material.

9. The cutting element of claim 1, further comprising a substrate on which the cutting element is disposed.

10. A method for forming a cutting element for an earth-boring drilling tool, the method comprising:
at least partially embedding at least one diamond crystal in a cutting element, the at least one diamond crystal being configured to generate a piezoelectric signal when the cutting element is drilling a borehole.

11. The method of claim 10 further comprising forming the cutting element at least partially of a polycrystalline diamond material.

12. The method of claim 11, applying a HPHT synthesis to the cutting element after the at least one diamond crystal is embedded in the cutting element.

13. The method of claim 12, forming a cutting surface on the cutting element after the HPHT synthesis.

14. The method of claim 13, wherein at least a portion of the at least one diamond crystal is exposed on the cutting surface.

15. A method for measuring a property of a cutting element of an earth-boring drilling tool, the method comprising:
determining the property of the cutting element using a piezeoelectric response of a diamond crystal embedded in the cutting element.

16. The method of claim 15 wherein the property comprises pressure.

17. The method of claim 15 wherein the property is determined while the cutting element is engaging an earthen formation.
